(19) United States
(12) Patent Application Publication
(10) Pub. No.: US 2025/0208266 A1
(43) Pub. Date: Jun. 26, 2025

(54) RANGING DEVICE, RANGING METHOD, AND MOVABLE BODY

(71) Applicant: CANON KABUSHIKI KAISHA, Tokyo (JP)

(72) Inventors: YUUTA OOSHIMA, Saitama (JP); MASASHI NIWA, Chiba (JP)

(21) Appl. No.: 18/983,685

(22) Filed: Dec. 17, 2024

(30) Foreign Application Priority Data
Dec. 25, 2023 (JP) 2023-218494

(51) Int. Cl. G01S 7/484; G01S 7/486; G01S 7/4865; G01S 17/14; G01S 17/931

(52) U.S. Cl. CPC G01S 7/484; G01S 7/4865; G01S 7/4868; G01S 17/14; G01S 17/931

(57) ABSTRACT

A ranging device includes a light emission control unit configured to control a light emitting unit; a light receiving unit; an exposure period setting unit configured to set one of a plurality of detection periods to an exposure period of the light receiving unit for each emission of the pulse light; and a count holding unit configured to count and hold the number of the pulse signals in each of the exposure periods, wherein when each of the plurality of detection periods is set, the light emission control unit causes the pulse light to be emitted at irregular light emission intervals that are shorter than a length corresponding to a length of a unit detection period which is defined as a period from the emission of the pulse light to an elapse of the detection period having the latest start timing among the plurality of detection periods.

### BACKGROUND

### Technical Field

The present invention relates to a ranging device, a ranging method, and movable body.

### Description of the Related Art

Conventionally, a ranging method called a time of flight (TOF) is known as one of ranging methods for measuring a distance to an object using light. The TOF method measures a distance to the object based on a time from light emission toward the object to detection of light reflected by the object. Under an environment in which a plurality of similar ranging devices exist, the light emission interval of the ranging device itself and the light emission interval of the other ranging devices may be the same interval. In this case, there is a problem of interference between devices in that light emitted by another ranging device is erroneously recognized as the reflected light from the object. In order to solve this problem, a laser radar device according to Japanese Patent Application Laid-Open No. 2019-158894 randomly sets a light emission timing of pulse light when the pulse light is emitted from a light emission unit onto a target object in a ranging cycle.

### SUMMARY

However, in the laser radar device according to Japanese Patent Application Laid-Open No. 2019-158894, when the light emission timing of the pulse light is set randomly, the light emission interval is lengthened from the shortest light emission interval, and thus frame rate may decrease.

An advantage of some aspects of the invention is to provide a ranging device, a ranging method, and a movable body capable of suppressing interference with other ranging devices while suppressing a decrease in frame rate.

According to a disclosure of the present specification, there is provided a ranging device including: a light emission control unit configured to control a light emitting unit that emits a pulse light; a light receiving unit configured to detect a light signal including light emitted from the light emitting unit and reflected by an object in a measurement target region and convert the light signal into a pulse signal; an exposure period setting unit configured to set one of a plurality of detection periods to an exposure period of the light receiving unit for each emission of the pulse light, wherein the plurality of detection periods are determined according to a time from emission of the light to detection of the light; and a count holding unit configured to count and hold the number of the pulse signals in each of the exposure periods, wherein when each of the plurality of detection periods is set, the light emission control unit causes the pulse light to be emitted at irregular light emission intervals that are shorter than a length corresponding to a length of a unit detection period which is defined as a period from the emission of the pulse light to an elapse of the detection period having the latest start timing among the plurality of detection periods.

According to a disclosure of the present specification, there is provided a ranging device including: a light emission control unit configured to control a light emitting unit that emits a pulse light; a light receiving unit configured to detect a light signal including light emitted from the light emitting unit and reflected by an object in a measurement target region and convert the light signal into a pulse signal; an exposure period setting unit configured to set one of a plurality of detection periods to an exposure period of the light receiving unit for each emission of the pulse light, wherein the plurality of detection periods are determined according to a time from emission of the light to detection of the light; and a count holding unit configured to count and hold the number of the pulse signals in each of the exposure periods, wherein the exposure period setting unit outputs detection period information indicating the detection period to the light emission control unit, wherein the light emission control unit determines a light emission period in which the light emitting unit is caused to emit light based on a start timing of a detection period indicated by the detection period information, outputs a light emission control signal indicating that the light emitting unit emits light in the light emission period to the light emitting unit, and further outputs a light emission notification indicating that the light emitting unit is controlled to emit light in the light emission period to the exposure period setting unit, wherein the exposure period setting unit sets the detection period to the light receiving unit based on the light emission notification.

According to a disclosure of the present specification, there is provided a ranging method including: controlling a light emitting unit that emits a pulse light; setting one of a plurality of detection periods to an exposure period of a light receiving unit for each emission of the pulse light, wherein the light receiving unit detects a light signal including light emitted from the light emitting unit and reflected by an object in a measurement target region and converts the light signal into a pulse signal, wherein the plurality of detection periods are determined according to a time from emission of the light to detection of the light; and counting and holding the number of the pulse signals in each of the exposure periods, wherein when each of the plurality of detection periods is set, the controlling causes the pulse light to be emitted at irregular light emission intervals that are shorter than a length corresponding to a length of a unit detection period which is defined as a period from the emission of the pulse light to an elapse of the detection period having the latest start timing among the plurality of detection periods.

Further features of the present invention will become apparent from the following description of exemplary embodiments with reference to the attached drawings.

### BRIEF DESCRIPTION OF THE DRAWINGS

FIG. 1 is a hardware block diagram illustrating a configuration example of a ranging device according to a first embodiment.

FIG. 2 is a functional block diagram illustrating a configuration example of a light emitting device, a light receiving device, and a signal processing device according to the first embodiment.

FIG. 3 is a diagram illustrating a frame period, a sub-frame period, and a micro-frame period according to the first embodiment.

FIG. 4A, FIG. 4B, and FIG. 4C are diagrams illustrating control examples of an exposure period and a light emission interval according to the first embodiment.

FIG. 5 is a flowchart illustrating an operation example of the ranging device according to the first embodiment.

FIG. 6 is a diagram illustrating a control example of the exposure period and the light emission interval according to the second embodiment.

FIGS. 7A and 7B are diagrams illustrating an example of control of the exposure period and the light emission interval according to the third embodiment.

FIGS. 8A and 8B are diagrams illustrating a configuration example of a movable body according to the fourth embodiment.

### DESCRIPTION OF THE EMBODIMENTS

Preferred embodiments of the present invention will now be described in detail in accordance with the accompanying drawings.

### First Embodiment

A ranging device and a ranging method according to the first embodiment will be described. The ranging device described in the present embodiment adapts a technique such as LiDAR (Light Detection And Ranging). The ranging device measures a distance from the ranging device to an object based on a time difference from when light is emitted from the light emitting device toward a measurement target region to when light reflected by the object included in the measurement target region is received by a light receiving device. In addition, the ranging device is a so-called time gate type device, in which an exposure period (gate period) is switched according to a distance, and a distance to the object is measured based on information of the exposure period in which the reflected light from the object is received.

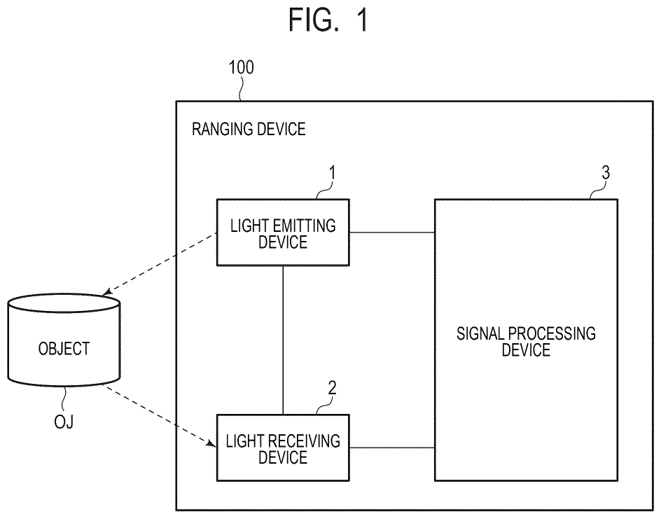

FIG. 1 is a hardware block diagram illustrating a configuration example of a ranging device 100. As illustrated in FIG. 1, the ranging device 100 includes a light emitting device 1, a light receiving device 2, and a signal processing device 3. The light emitting device 1, the light receiving device 2, and the signal processing device 3 are connected to each other.

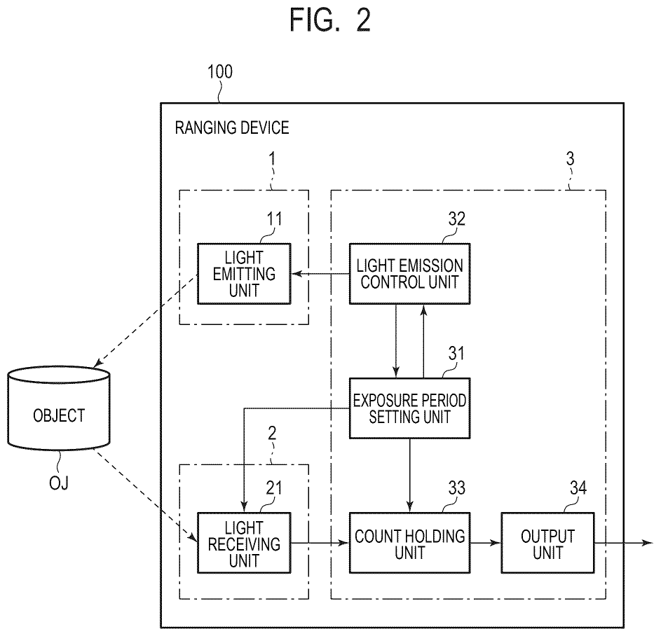

FIG. 2 is a functional block diagram illustrating a configuration example of the light emitting device 1, the light receiving device 2, and the signal processing device 3. The light emitting device 1 includes a light emitting unit 11 and emits light such as laser light as illustrated in FIG. 2. The light emitting unit 11 has a light emitting element (not illustrated) and operates to emit pulse lights from the light emitting element toward the measurement target region including the object OJ. The light emitting element constituting the light emitting unit 11 may be an element capable of high-speed modulation such as an LED (Light Emitting Diode) or an LD (Laser Diode). The light-emitting element may be VCSEL (Vertical Cavity Surface Emitting Laser) or a surface light-emitting element in which the VCSELs are arranged in an array. The light emitting unit 11 is preferably configured to emit light having a uniform amount of light to the measurement target region. The light emitting unit 11 may further include a light element, for example, a lens, for lightly converting the light emitted from the light emitting element into light to be emitted to the measurement target region.

The light receiving device 2 includes a light receiving unit 21 and receives light. The light receiving unit 21 has one or a plurality of light receiving elements (not illustrated) and operates to receive light incident from the measurement target region. The light receiving elements constituting the light receiving unit 21 are arranged in a two-dimensional shape, for example, in a matrix shape, and measure distances at a plurality of points in a two-dimensional shape by receiving the reflected light from the object OJ. The light receiving elements, for example, may be a CMOS (Complementary Metal-Oxide-Semiconductor) sensor, a SPAD (Single Photon Avalanche Diode) sensor, or the like. In the case of the SPAD sensor, one pulse is generated in response to one photon entering the avalanche photodiode. The light incident on the light receiving unit 21 includes ambient light such as sunlight in addition to light reflected by the object OJ in the measurement target region. The light receiving unit 21 detects a light signal including light emitted from the light emitting unit 11 and reflected by the object OJ in the measurement target region, converts the light signal into a pulse signal (electric signal), and outputs the pulse signal to the signal processing device 3. The light receiving unit 21 may further include a light element, such as a lens, for efficiently guiding the reflected light to the light receiving element.

The signal processing device 3 controls a light emission interval of light emitted from the light emitting device 1 and processes a pulse signal output from the light receiving device 2. The signal processing device 3 may include a processor that performs arithmetic processing of a digital signal, a memory that stores a digital signal, and the like. The signal processing device 3 may be, for example, an integrated circuit such as a FPGA (Field-Programmable Gate Array) or an ISP (Image Signal Processor). The signal processing device 3 includes an exposure period setting unit 31, a light emission control unit 32, a count holding unit 33, and an output unit 34. The exposure period setting unit 31 is connected to the light emission control unit 32 and the light receiving unit 21. The light emission control unit 32 is connected to the light emitting unit 11 and the exposure period setting unit 31. The count holding unit 33 is connected to the light receiving unit 21 and the output unit 34. The output unit 34 is connected to the count holding unit 33 and an external device (not illustrated).

The exposure period setting unit 31 operates to set any one of a plurality of detection periods determined according to a time from emission of light to detection of light to the exposure period of the light receiving unit 21. Here, In the exposure period, a signal based on incident light is generated in the light receiving unit 21. The exposure period setting unit 31 generates an exposure control signal for controlling a timing of a start and an end of the exposure period in the light receiving unit 21, and outputs the exposure control signal to the light receiving unit 21.

The light emission control unit 32 operates to control the light emission interval of the light emitting unit 11. The light emission control unit 32 outputs a light emission control signal to the light emitting unit 11 based on an exposure period information (detection period information) output from the exposure period setting unit 31 and controls the light emission interval of the light emitting unit 11.

The count holding unit 33 operates to count and hold the number of pulse signals generated in response to incidence of light within each exposure period. The count holding unit 33 counts and holds the pulse signal for each exposure period based on the exposure period information output from the exposure period setting unit 31 and the pulse signal output from the light receiving unit 21. For example, the count holding unit 33 sets the exposure period as a class, sets a count value obtained by counting the number of pulse signals as a frequency, and acquires frequency distribution information in which the class and the frequency are associated with each other. The count holding unit 33 outputs the frequency distribution information to the output unit 34.

The output unit 34 operates to output the frequency distribution information output from the count holding unit 33 to an external device (not illustrated). The output unit 34, for example, outputs the frequency distribution information to the external device every time one or a plurality of frame periods described later.

The external device operates to calculate a distance from the ranging device 100 to the object OJ based on the frequency distribution information output from the output unit 34. Here, the light incident on the light receiving unit 21 may include environmental light such as sunlight in addition to the light reflected by the object OJ. Therefore, the external device detects a peak from the frequency distribution information and specifies a class (exposure period) corresponding to the frequency of the peak. The specified exposure period is time information corresponding to a flight time of light from when the light is emitted from the light emitting unit 11 toward the measurement target region to when the light reflected by the object OJ included in the measurement target region is received by the light receiving unit 21. The external device calculates the distance from the ranging device 100 to the object OJ based on the specified exposure period.

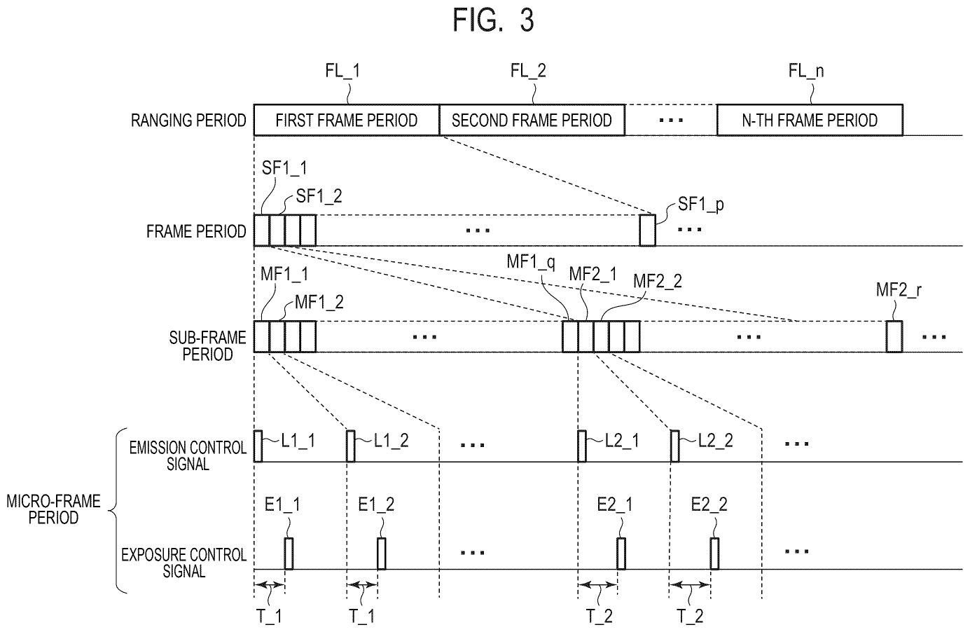

Next, various periods will be described with reference to FIG. 3. FIG. 3 is a diagram illustrating a frame period, a sub-frame period, and a micro-frame period according to the present embodiment. FIG. 3 illustrates a frame period in which frequency distribution information corresponding to one ranging result is acquired, a sub-frame period in which a sub-frame used to generate frequency distribution information is acquired, and a micro-frame period in which a micro-frame used to generate a sub-frame is acquired. Each of these periods is schematically illustrated by arranging blocks in the horizontal direction. The horizontal direction in FIG. 3 indicates a time, and one block indicates one frame period, sub-frame period, or micro-frame period. FIG. 3 also illustrates a light emission control signal for controlling the light emission period of the light emitting unit 11 and an exposure control signal for controlling the exposure period of the light receiving unit 21.

In the ranging period of FIG. 3, a plurality of frame periods FL_1, FL_2, . . . , FL_n are illustrated. That is, the first frame period FL_1, the second frame period FL_2, . . . , and the n-th frame period FL_n are illustrated (n is an integer of 3 or more).

One frame period includes a plurality of sub-frame periods. In the frame period of FIG. 3, a plurality of sub-frame periods SF1_1, SF1_2, . . . , SF1_p included in the first frame period FL_1 are illustrated. That is, a first sub-frame period SF1_1, a second sub-frame period SF1_2, and a p-th sub-frame period SF1_p are illustrated. In the present embodiment, the number of sub-frame periods in the first frame period FL_1 is p (p is an integer of 3 or more).

One sub-frame period includes a plurality of micro-frame periods. Here, the micro-frame period is an example of unit detection period and is a period from the emission of the pulse light to an elapse of the exposure period having the latest start timing among the exposure periods. In other words, In the micro-frame period, the light emitting unit 11 emits one pulse light and the light receiving unit 21 detects incident light in a predetermined exposure period. By repeatedly providing the micro-frame periods, the reflected light can be received in each exposure period. Each of micro-frame periods has a length for suppressing the influence of light emission in the previous micro-frame period on light reception in the next micro-frame period. In the present embodiment, the micro-frame period is the length obtained by multiplying the exposure period by an integral multiple (e.g., 10 times).

In the sub-frame period of FIG. 3, a plurality of micro-frame periods MF1_1, MF1_2, . . . , MF1_q included in the first sub-frame period SF1_1 are illustrated. That is, a first micro-frame period (first unit detection period) MF1_1, a second micro-frame period (second unit detection period) MF1_2, and a q-th micro-frame period MF_q are illustrated. In the present embodiment, the number of micro-frame periods in the first sub-frame period SF1_1 is q (q is an integer of 3 or more). The number q of the micro-frame periods corresponds to the number of times of integration of the light reception result.

Similarly, a plurality of micro-frame periods MF2_1, MF2_2, . . . , MF2_r included in the second sub-frame period SF1_2 are illustrated. That is, the first micro-frame period MF2_1, the second micro-frame period MF2_2, and the r-th micro-frame period MF_r are illustrated. In the present embodiment, the number of micro-frame periods in the second sub-frame period SF1_2 is assumed to be r (r is an integer of 3 or more). The number r of micro-frames corresponds to the number of times of integration of the light reception result.

The light emission control signal and the exposure control signal in FIG. 3 indicate the light emission control signal input to the light emitting unit 11 and the exposure control signal input to the light receiving unit 21 in one micro-frame period. The light emitting unit 11 emits light during a period in which the light emission control signal output from the light emission control unit 32 is at a high level. The light receiving unit 21 detects incident light in an exposure period in which the exposure control signal output from the exposure period setting unit 31 is at a high level.

In the first micro-frame period MF1_1, the light emitting unit 11 emits light in the first light emission period L1_1, and the light receiving unit 21 receives light in the first exposure period E1_1. In the second micro-frame period MF1_2, the light emitting unit 11 emits light in the second light emission period L1_2, and the light receiving unit 21 receives light in the second exposure period E1_2. The light emitting unit 11 emits light at a light emission interval between the first light emission period L1_1 and the second light emission period L1_2. Since the first micro-frame period MF1_1 and the second micro-frame period MF1_2 are included in the same first sub-frame period SF1_1, the first exposure period E1_1 and the second exposure period E1_2 have the same interval from the light emission. That is, a length of a period T_1 from a start of the first light emission period L1_1 to a start of the first exposure period E1_1 is the same as a length of a period T_1 from a start of the second light emission period L1_2 to a start of the second exposure period E1_2.

Similarly, in the first micro-frame period MF2_1, the light emitting unit 11 emits light in the first light emission period L2_1, and the light receiving unit 21 receives light in the first exposure period E2_1. In the second micro-frame period MF2_2, the light emitting unit 11 emits light in the second light emission period L2_2, and the light receiving unit 21 receives light in the second exposure period E2_2. The light emitting unit 11 emits light at a light emission interval between the first light emission period L2_1 and the second light emission period L2_2. Since the first micro-frame period MF2_1 and the second micro-frame period MF2_2 are included in the same second sub-frame period SF1_2, the first exposure period E2_1 and the second exposure period E2_2 have the same interval from the light emission. That is, a length of a period T_2 from a start of the first light emission period L2_1 to a start of the first exposure period E2_1 is the same as a length of the period T_2 from a start of the second light emission period L2_2 to a start of the second exposure period E2_2. These periods T_2 correspond to the flight time of the light from when the light is emitted from the light emitting unit 11 toward the measurement target region to when the light reflected by the object OJ included in the measurement target region is received by the light receiving unit 21. The period T_1 and the period T_2 have different lengths because the respective sub-frame periods are different. The difference between the length of the period T_1 and the length of the period T_2 corresponds to a length of one exposure period. When the sub-frame period shifts to the next sub-frame period, a timing of outputting the exposure control signal is shifted by the length of one exposure period. However, the relationship between the sub-frame period and the timing of outputting the exposure control signal is not limited to this.

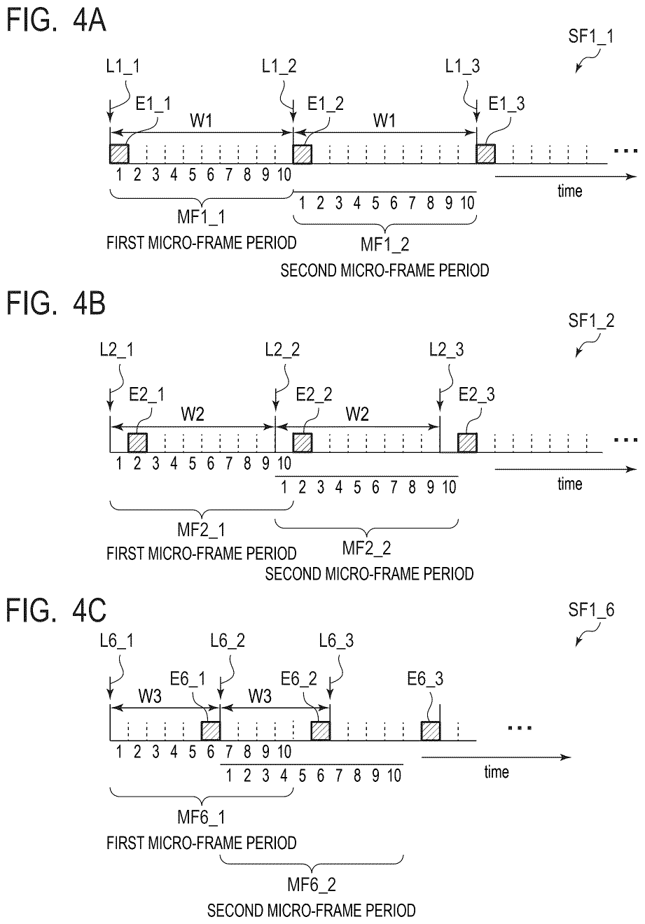

Next, an example of controlling the exposure period and the light emission interval will be described in detail. FIGS. 4A to 4C are diagrams illustrating control examples of the exposure period and the light emission interval according to the present embodiment. In the present embodiment, the exposure period is set corresponding to each of the regions obtained by dividing the measurement target region in a depth direction (direction in which light is emitted from the light emitting unit 11). For example, as illustrated in FIGS. 4A to 4C, the measurement target region is divided into ten regions (regions corresponding to distance values 1 to 10) in the depth direction, and the exposure period is set corresponding to each of the ten regions. The distance values 1 to 10 illustrated in FIGS. 4A to 4C are numerical values proportional to a distance from when the light is emitted from the light emitting unit 11 toward the measurement target region to when the light reflected by the object OJ included in the measurement target region is received by the light receiving unit 21. The distance values 1 to 10 indicate numerical values proportional to the time of flight of light such as the above-described periods T_1 and T_2. In the exposure period corresponding to the distance values 1 to 10, the distance to the object OJ can be measured based on a count value obtained by counting the number of pulse signals generated in accordance with the incidence of light in each exposure period.

The exposure period setting unit 31 sets any one of the exposure periods corresponding to the distance values 1 to 10 in each of the micro-frame periods. For example, the exposure period setting unit 31 sets the exposure period corresponding to the distance value 1. After that, when the sub-frame period shifts to the next sub-frame period, the exposure period setting unit 31 switches to another exposure period (for example, the exposure period corresponding to the distance value 2) among the exposure periods corresponding to the distance values 1 to 10. The exposure period setting unit 31 sets the exposure period corresponding to the distance value 2 to each of the micro-frame periods. The exposure period setting unit 31 performs the same processing until all the exposure periods are set.

The first sub-frame period SF1_1 illustrated in FIG. 4A includes the micro-frame periods MF1. In the first micro-frame period MF1_1, the light emission period L1_1 and the exposure period E1_1 are illustrated. In the second micro-frame period MF1_2, the light emission period L1_2 and the exposure period E1_2 are illustrated. In each of the micro-frame periods MF1_1 and MF1_2, distance values 1 to 10 proportional to the distance to the object OJ are described.

The exposure period setting unit 31 determines the first exposure period E1_1 in the first micro-frame period MF1_1 illustrated in FIG. 4A. In the first exposure period E1_1, the reflected light caused by the light emitted from the light emitting unit 11 in the first light emission period L1_1 can be received. Specifically, in the first exposure period E1_1, the reflected light from the object OJ at the distance value 1 with respect to the first light emission period L1_1 can be received. The exposure period setting unit 31 outputs exposure period information indicating the first exposure period E1_1 to the light emission control unit 32 and the count holding unit 33.

The light emission control unit 32 outputs the light emission control signal indicating light emission in the first light emission period L1_1 to the light emitting unit 11 based on the first exposure period E1_1 determined by the exposure period setting unit 31. The light emission control unit 32 arbitrarily sets the first light emission period L1_1. In this case, the first light emission period L1_1 may be set so as to cause to the light emitting unit 11 to emit light immediately or emit light after waiting for a predetermined period. The light emitting unit 11 emits light in the first light emission period L1_1 based on the light emission control signal output from the light emission control unit 32. The light emission control unit 32 outputs a light emission notification indicating that the light emission is performed in the first light emission period L1_1 to the exposure period setting unit 31.

The exposure period setting unit 31 outputs an exposure control signal indicating the first exposure period E1_1 to the light receiving unit 21 at the start timing of the first exposure period E1_1 based on the light emission notification output from the light emission control unit 32. When the light receiving unit 21 receives the reflected light from the object OJ in the first exposure period E1_1, the light receiving unit 21 converts the received light into an electrical pulse signal, and outputs the converted pulse signal to the count holding unit 33. When the reflected light is not incident, the light receiving unit 21 does not output the pulse signal to the count holding unit 33.

The count holding unit 33 counts and holds the pulse signal for each exposure period based on the pulse signal output from the light receiving unit 21 and the exposure period information (for example, the first exposure period E1_1) output from the exposure period setting unit 31.

Next, the second micro-frame period MF1_2 will be described. The second micro-frame period MF1_2 is next to the first micro-frame period MF1_1 in the first sub-frame period SF1_1. The exposure period setting unit 31 determines the second exposure period E1_2 in the second micro-frame period MF1_2. In the second exposure period E1_2, the reflected light caused by the light emitted from the light emitting unit 11 in the second light emission period L1_2 can be received. Specifically, in the second exposure period E1_2, the reflected light from the object OJ at the distance value 1 with respect to the second light emission period L1_2 can be received as in the previous case. The exposure period setting unit 31 outputs exposure period information indicating the second exposure period E1_2 to the light emission control unit 32 and the count holding unit 33.

Based on the second exposure period E1_2 determined by the exposure period setting unit 31, the light emission control unit 32 controls a light emission interval W1 between the previous first light emission period L1_1 and the next second light emission period L1_2. In this case, the light emission control unit 32 controls the second light emission period L1_2 so that the second exposure period E1_2 is outside the first micro-frame period MF1_1. This is to prevent the reflected light caused by the light emitted in the first light emission period L1_1 from being erroneously received in the second exposure period E1_2. That is, by setting the exposure period at a sufficient interval so as not to be affected by the previous light emission, interference due to self-light emission is suppressed. In the present embodiment, the second exposure period E1_2 is controlled immediately after the end of the first micro-frame period MF1_1. Since the second exposure period E1_2 corresponds to the distance value 1, the second light emission period L1_2 corresponding to the second exposure period E1_2 is controlled immediately after the end of the first micro-frame period MF1_1. The light emission interval W1 between the first light emission period L1_1 and the second light emission period L1_2 corresponds to an interval including ten exposure periods. In this way, the light emission control unit 32 controls the second light emission period L1_2 between the end of the first exposure period E1_1 and the end of the first micro-frame period MF1_1 so that the second exposure period E1_2 is after the end of the first micro-frame period MF1_1. The light emission control unit 32 outputs a light emission control signal indicating light emission in the second light emission period L1_2 to the light emitting unit 11. The light emitting unit 11 emits light in the second light emission period L1_2 based on the light emission control signal output from the light emission control unit 32. The light emission control unit 32 outputs a light emission notification indicating that the light emission is performed in the second light emission period L1_2 to the exposure period setting unit 31.

The exposure period setting unit 31 outputs an exposure control signal indicating the second exposure period E1_2 to the light receiving unit 21 at the start timing of the second exposure period E1_2 based on the light emission notification output from the light emission control unit 32. When the reflected light from the object OJ in the second exposure period E1_2 is incident, the light receiving unit 21 converts the received light into an electrical pulse signal, and outputs the converted pulse signal to the count holding unit 33.

The count holding unit 33 counts and holds the pulse signal for each exposure period based on the pulse signal output from the light receiving unit 21 and the exposure period information (the second exposure period E1_2) output from the exposure period setting unit 31.

In the first sub-frame period SF1_1, following the first micro-frame period MF1_1 and the second micro-frame period MF1_2, the same processing is repeated until the q-th micro-frame period MF1_q (q is an integer of 3 or more). As described above, in the first sub-frame period SF1_1, the micro-frame period MF1 is repeated q times, and the exposure period in which the reflected light from the object OJ at the distance value 1 can be received is set a plurality of times (q times).

Next, the second sub-frame period SF1_2 illustrated in FIG. 4B will be described. The second sub-frame period SF1_2 is a sub-frame period next to the first sub-frame period SF1_1. The second sub-frame period SF1_2 includes a plurality of micro-frame periods MF2. In the first micro-frame period MF2_1, a light emission period L2_1 and an exposure period E2_1 are illustrated. In the second micro-frame period MF2_2, the light emission period L2_2 and the exposure period E2_2 are illustrated. In each of the micro-frame periods MF2_1 and MF2_2, distance values 1 to 10 proportional to the distance to the object OJ are described.

When the sub-frame period shifts from the first sub-frame period SF1_1 to the second sub-frame period SF1_2, the exposure period setting unit 31 switches the exposure period. The exposure period setting unit 31 switches, for example, the exposure period of the distance value 1 to the exposure period of the distance value 2. The first exposure period E2_1 indicating the exposure period of the distance value 2 is a period obtained by shifting the first exposure period E1_1 indicating the exposure period of the distance value 1 by a period of one exposure period. In the first exposure period E2_1, the reflected light from the object OJ at the distance value 2 with respect to the first light emission period L2_1 can be received. The exposure period setting unit 31 outputs exposure period information indicating the first exposure period E2_1 to the light emission control unit 32 and the count holding unit 33.

The light emission control unit 32 outputs a light emission control signal indicating light emission in the first light emission period L2_1 to the light emitting unit 11 based on the first exposure period E2_1 determined by the exposure period setting unit 31. The light emitting unit 11 emits light in the first light emission period L2_1 based on the light emission control signal output from the light emission control unit 32. The light emission control unit 32 outputs a light emission notification indicating that the light emission is performed in the first light emission period L2_1 to the exposure period setting unit 31.

The exposure period setting unit 31 outputs an exposure control signal indicating the first exposure period E2_1 to the light receiving unit 21 at the start timing of the first exposure period E2_1 based on the light emission notification output from the light emission control unit 32. When the reflected light from the object OJ in the first exposure period E2_1 is incident, the light receiving unit 21 converts the received light into an electrical pulse signal, and outputs the converted pulse signal to the count holding unit 33.

The count holding unit 33 counts and holds the pulse signal for each exposure period based on the pulse signal output from the light receiving unit 21 and the exposure period information (first exposure period E2_1) output from the exposure period setting unit 31.

Next, the second micro-frame period MF2_2 will be described. The second micro-frame period MF2_2 is a micro-frame period next to the first micro-frame period MF2_1 in the second sub-frame period SF1_2. The exposure period setting unit 31 determines the second exposure period E2_2 in the second micro-frame period MF2_2. In the second exposure period E2_2, the reflected light from the object OJ at the distance value 2 with respect to the second light emission period L2_2 can be received as in the previous case. The exposure period setting unit 31 outputs exposure period information indicating the determined second exposure period E2_2 to the light emission control unit 32 and the count holding unit 33.

Based on the second exposure period E2_2 determined by the exposure period setting unit 31, the light emission control unit 32 controls the light emission interval W2 between the previous first light emission period L2_1 and the next second light emission period L2_2. In this case, the light emission control unit 32 controls the light emission interval W2 so that the second exposure period E2_2 is outside the first micro-frame period MF2_1. This is to prevent the reflected light caused by the light emitted in the first light emission period L2_1 from being erroneously received in the second exposure period E2_2. In the present embodiment, the second exposure period E2_2 is immediately after the end of the first micro-frame period MF2_1. Since the second exposure period E2_2 corresponds to the distance value 2, the second light emission period L2_2 corresponding to the second exposure period E2_2 is before the end of the first micro-frame period MF2_1. Specifically, the second light emission period L2_2 is before the distance value 10 of the first micro-frame period MF2_1. A light emission interval W2 between the first light emission period L2_1 and the second light emission period L2_2 corresponds to an interval including nine exposure periods and is different from the light emission interval W1 corresponding to an interval including ten exposure periods. As described above, the light emission control unit 32 changes the light emission interval while making the light emission interval shorter than the micro-frame period every time the exposure period is switched. Specifically, the light emission control unit 32 makes the light emission interval W2 of the second sub-frame period SF1_2 shorter than the micro-frame period when switching from the exposure period of the distance value 1 to the exposure period of the distance value 2. Then, the light emission control unit 32 changes the light emission interval W2 so as to be different from the light emission interval W1 of the first sub-frame period SF1_1. Thus, the ranging device 100 can suppress interference with other ranging devices while suppressing a decrease in frame rate. The light emission control unit 32 outputs a light emission control signal indicating light emission in the second light emission period L2_2 to the light emitting unit 11. The light emitting unit 11 emits light in the second light emission period L2_2 based on the light emission control signal output from the light emission control unit 32. The light emission control unit 32 outputs a light emission notification indicating that the light emission is performed in the second light emission period L2_2 to the exposure period setting unit 31.

The exposure period setting unit 31 outputs an exposure control signal indicating the second exposure period E2_2 to the light receiving unit 21 at the start timing of the second exposure period E2_2 based on the light emission notification output from the light emission control unit 32. When the reflected light from the object OJ in the second exposure period E2_2 is incident, the light receiving unit 21 converts the received light into an electrical pulse signal, and outputs the converted pulse signal to the count holding unit 33.

The count holding unit 33 counts and holds the pulse signal for each exposure period based on the pulse signal output from the light receiving unit 21 and the exposure period information (the second exposure period E2_2) output from the exposure period setting unit 31.

In the second sub-frame period SF1_2, following the first micro-frame period MF2_1 and the second micro-frame period MF2_2, similar processing is repeated until the r-th micro-frame period MF2_r (r is an integer of 3 or more). As described above, in the second sub-frame period SF1_2, the micro-frame period MF2 is repeated r times, and the exposure period in which the reflected light from the object OJ at the distance value 2 can be received is set a plurality of times (r times).

Since the third to fifth sub-frame periods are configured similarly to those of the first and second sub-frame periods, the description of the third to fifth sub-frame periods will be omitted, and the sixth sub-frame period SF1_6 will be described. The sixth sub-frame period SF1_6 illustrated in FIG. 4C includes a plurality of micro-frame periods MF6. In the first micro-frame period MF6_1, a light emission period L6_1 and an exposure period E6_1 are illustrated. In the second micro-frame period MF6_2, the light emission period L6_2 and the exposure period E6_2 are illustrated. In each of the micro-frame periods MF6_1 and MF6_2, distance values 1 to 10 proportional to the distance to the object OJ are described.

The exposure period setting unit 31 determines the first exposure period E6_1 when the fifth sub-frame period SF1_5 shifts to the sixth sub-frame period SF1_6. In the first exposure period E6_1, the reflected light from the object OJ at the distance value 6 with respect to the first light emission period L6_1 can be received. The exposure period setting unit 31 outputs exposure period information indicating the first exposure period E6_1 to the light emission control unit 32 and the count holding unit 33.

The light emission control unit 32 outputs a light emission control signal indicating light emission in the first light emission period L6_1 to the light emitting unit 11 based on the first exposure period E6_1 determined by the exposure period setting unit 31. The light emitting unit 11 emits light in the first light emission period L6_1 based on the light emission control signal output from the light emission control unit 32. The light emission control unit 32 outputs a light emission notification indicating that the light emission is performed in the first light emission period L6_1 to the exposure period setting unit 31.

The exposure period setting unit 31 outputs an exposure control signal indicating the first exposure period E6_1 to the light receiving unit 21 at the start timing of the first exposure period E6_1 based on the light emission notification output from the light emission control unit 32. When the reflected light from the object OJ in the first exposure period E6_1 is incident, the light receiving unit 21 converts the received light into an electrical pulse signal, and outputs the converted pulse signal to the count holding unit 33.

The count holding unit 33 counts and holds the pulse signal for each exposure period based on the pulse signal output from the light receiving unit 21 and the exposure period information (first exposure period E6_1) output from the exposure period setting unit 31.

Next, the second micro-frame period MF6_2 will be described. The second micro-frame period MF6_2 is next to the first micro-frame period MF6_1 in the sixth sub-frame period SF1_6. The exposure period setting unit 31 determines the second exposure period E6_2 in the second micro-frame period MF6_2. In the second exposure period E6_2, the reflected light from the object OJ at the distance value 6 with respect to the second light emission period L6_2 can be received as in the previous case. The exposure period setting unit 31 outputs exposure period information indicating the second exposure period E6_2 to the light emission control unit 32 and the count holding unit 33.

Based on the second exposure period E6_2 determined by the exposure period setting unit 31, the light emission control unit 32 controls a light emission interval W3 between the previous first light emission period L6_1 and the next second light emission period L6_2. In this case, the light emission control unit 32 controls the light emission interval W3 so that the next second exposure period E6_2 is outside the first micro-frame period MF6_1. This is to prevent the reflected light caused by the light emitted in the first light emission period L6_1 from being erroneously received in the second exposure period E6_2. In the present embodiment, the second exposure period E6_2 is set with one exposure period after the end of the first micro-frame period MF6_1. Since the second exposure period E6_2 corresponds to the distance value 6, the second light emission period L6_2 corresponding to the second exposure period E6_2 is before the end of the first micro-frame period MF6_1. Specifically, the second light emission period L6_2 is before the distance value 7 of the first micro-frame period MF6_1. A light emission interval W3 between the first light emission period L6_1 and the second light emission period L6_2 corresponds to an interval including six exposure periods. Here, when the second light emission period L6_2 is earlier than the distance value 7 of the first micro-frame period MF6_1, the reflected light caused by the light emitted in the second light emission period L6_2 can be received in the first exposure period E6_1. Therefore, the light emission control unit 32 controls the second light emission period L6_2 immediately after the first exposure period E6_1. As described above, the light emission control unit 32 changes the light emission interval while making the light emission interval shorter than the micro-frame period every time the exposure period is switched. Specifically, when switching from the exposure period of the distance value 5 to the exposure period of the distance value 6, the light emission control unit 32 changes the light emission interval W3 so as to be different from the light emission intervals W1 and W2 described above while making the light emission interval W3 of the sixth sub-frame period SF1_6 shorter than the micro-frame period. In this case, the light emission control unit 32 controls the second light emission period L6_2 between the end of the first exposure period E6_1 and the end of the first micro-frame period MF6_1. Accordingly, the ranging device 100 can suppress interference with other ranging devices while suppressing a decrease in the frame rate. The light emission control unit 32 outputs a light emission control signal indicating light emission in the second light emission period L6_2 to the light emitting unit 11. The light emitting unit 11 emits light in the second light emission period L6_2 based on the light emission control signal output from the light emission control unit 32. The light emission control unit 32 outputs a light emission notification indicating that the light emission is performed in the second light emission period L6_2 to the exposure period setting unit 31.

The exposure period setting unit 31 outputs an exposure control signal indicating the second exposure period E6_2 to the light receiving unit 21 at the start timing of the second exposure period E6_2 based on the light emission notification output from the light emission control unit 32. When the reflected light from the object OJ in the second exposure period E6_2 is incident, the light receiving unit 21 converts the received light into an electrical pulse signal, and outputs the converted pulse signal to the count holding unit 33.

The count holding unit 33 counts and holds the pulse signal for each exposure period based on the pulse signal output from the light receiving unit 21 and the exposure period information (the second exposure period E6_2) output from the exposure period setting unit 31.

In the sixth sub-frame period SF1_6, following the first micro-frame period MF6_1 and the second micro-frame period MF6_2, the same processing is repeated until the s-th micro-frame period MF6_s (s is an integer of 3 or more). As described above, in the sixth sub-frame period SF1_6, the micro-frame period MF6 is repeated s times, and the exposure period in which the reflected light from the object OJ at the distance value 6 can be received is set a plurality of times (s times).

Although the first frame period FL_1 includes the first to p-th sub-frame periods, since the seventh to p-th sub-frame periods are configured similarly to those of the first to sixth sub-frame periods described above, description thereof will be omitted (p is an integer of 8 or more). Since the second frame period FL_2 to n-th frame period to FL_n are processed in the same manner as the first frame period FL_1, description thereof will be omitted (n is an integer of 3 or more).

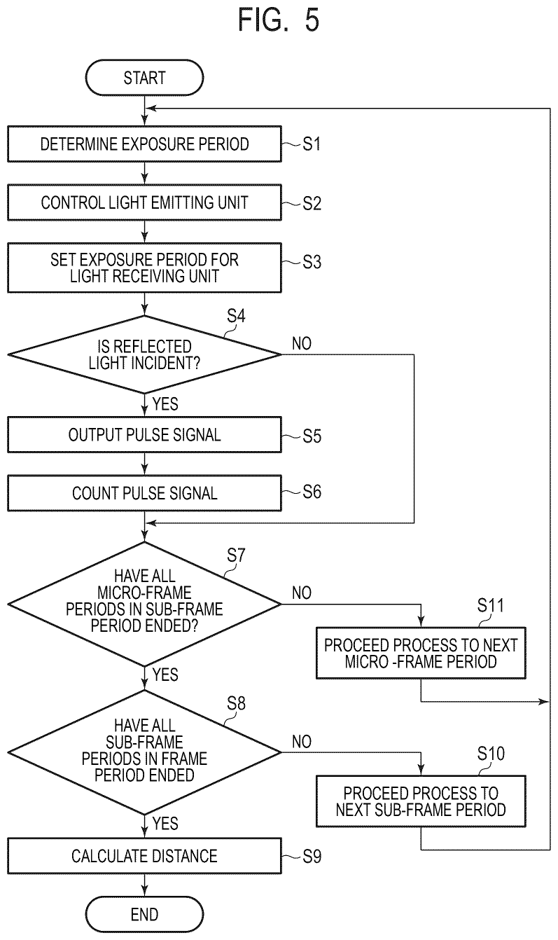

Next, an operation example of the ranging device 100 will be described with reference to FIG. 5. FIG. 5 is a flowchart illustrating an operation example of the ranging device 100. FIG. 5 illustrates an example in which the ranging device 100 measures the distance to the object OJ in one frame period (for example, the first frame period FL_1). In step S1 (detection period setting step), the exposure period setting unit 31 determines an exposure period (detection period). For example, the exposure period setting unit 31 determines the first exposure period E1_1 in the first micro-frame period MF1_1 illustrated in FIG. 4A. The exposure period setting unit 31 outputs exposure period information indicating the first exposure period E1_1 to the light emission control unit 32 and the count holding unit 33.

In step S2, the light emission control unit 32 controls the light emitting unit 11 based on the exposure period information. For example, based on the first exposure period E1_1 determined by the exposure period setting unit 31, the light emission control unit 32 outputs a light emission control signal indicating that light is emitted in the first light emission period L1_1 to the light emitting unit 11. Since the light emission period is not set before the first light emission period L1_1 and becomes the first light emission period, the first light emission period L1_1 is set to an arbitrary timing. The light emission control unit 32 outputs a light emission notification indicating that the light emission is performed in the first light emission period L1_1 to the exposure period setting unit 31.

In step S3, the exposure period setting unit 31 sets an exposure period for the light receiving unit 21. For example, the exposure period setting unit 31 outputs an exposure control signal indicating the first exposure period E1_1 to the light receiving unit 21 at the start timing of the first exposure period E1_1 based on the light emission notification output from the light emission control unit 32.

In step S4, when the reflected light from the object OJ in the first exposure period E1_1 is incident (step S4; YES), in step S5, the light receiving unit 21 converts the received light into a pulse signal of an electrical signal, and the light receiving unit 21 outputs the converted pulse signal to the count holding unit 33.

In step S6, the count holding unit 33 counts and holds the pulse signal for each exposure period. For example, the count holding unit 33 counts and holds the pulse signal for each exposure period based on the pulse signal output from the light receiving unit 21 and the exposure period information (first exposure period E1_1) output from the exposure period setting unit 31. The count holding unit 33 sets the exposure period as a class, sets the count value of the pulse signal as a frequency, and acquires frequency distribution information in which the class and the frequency are associated with each other.

In step S7, the exposure period setting unit 31 determines whether or not all the micro-frame periods have ended in the sub-frame period. For example, the exposure period setting unit 31 determines whether or not all of the micro-frame periods MF1_1 to MF1_q have ended in the first sub-frame period SF1_1. When it is determined that all the micro-frame periods have ended in the sub-frame period (step S7; YES), in step S8, the exposure period setting unit 31 determines whether or not all the sub-frame periods have ended in the frame period. When it is determined that all the sub-frame periods have ended in the frame period (step S8; YES), the output unit 34 outputs frequency distribution information indicating the frequency distribution acquired by the count holding unit 33 to the external device. In step S9, the external device calculates the distance from the ranging device 100 to the object OJ based on the frequency distribution information output from the output unit 34, and ends the process.

In step S8, when it is determined that all the sub-frame periods have not ended in the frame period (step S8; NO), in step S10, the process proceeds to the next sub-frame period. Then, in step S1, the exposure period setting unit 31 determines the exposure period in the micro-frame period of the next sub-frame period. In step S7, when it is determined that all the micro-frame periods have not ended in the sub-frame period (step S7; NO), in step S11 the process proceeds to the next micro-frame period. In step S1, the exposure period setting unit 31 determines an exposure period in the next micro-frame period. In step S4, when the reflected light is not incident in the first exposure period E1_1 (step S4; NO), the light receiving unit 21 does not output the pulse signal to the count holding unit 33, and the process proceeds to step S7.

As described above, in the ranging device 100 and the ranging method according to the present embodiment, the exposure period setting unit 31 sets any one of a plurality of exposure periods determined according to the time from emission of light to detection of light to the light receiving unit 21, for each light emission of the light emitting unit 11. When each of the exposure periods is executed, the light emission control unit 32 causes the light emitting unit 11 to emit light at an irregular light emission interval shorter than the length corresponding to the length of the micro-frame period. With this configuration, the ranging device 100 can suppress interference with other ranging devices while suppressing a decrease in frame rate. It should be noted that irregular means not constant. The irregular light emission interval indicates that the light emission interval is not constant, and includes, for example, that the light emission interval is changed by a predetermined interval every predetermined cycle, that the light emission interval is changed at random, and the like. The process of randomly changing the light emission interval will be described later.

In the ranging device 100, the light emission control unit 32 controls the light emission interval so that each of the exposure periods is after the end of the micro-frame period corresponding to the previous exposure period. With this configuration, it is possible to suppress the influence of the light emission in the previous micro-frame period on the exposure period in the next micro-frame period.

In the ranging device 100 according to the present embodiment, the exposure period setting unit 31 outputs exposure period information indicating an exposure period to the light emission control unit 32. The light emission control unit 32 determines a light emission period in which the light emitting unit 11 emits light based on the start timing of the exposure period indicated by the exposure period information. Then, the light emission control unit 32 outputs a light emission control signal indicating that light emission is performed in the light emission period to the light emitting unit 11, and further outputs a light emission notification indicating that light emission is performed on the light emitting unit 11 in the light emission period to the exposure period setting unit 31. The exposure period setting unit 31 sets the exposure period for the light receiving unit 21 based on the light emission notification. With this configuration, the ranging device 100 can appropriately perform the process from light emission to light reception.

### Second Embodiment

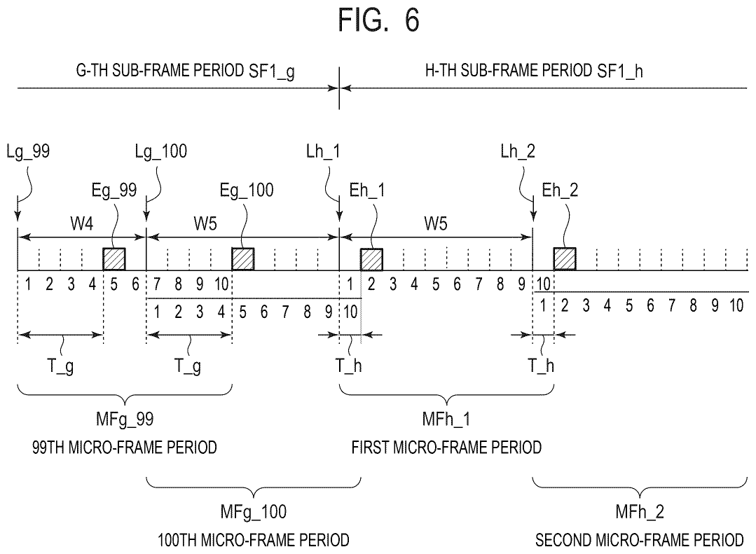

Next, an example of controlling the exposure period and the light emission interval according to the second embodiment will be described. The second embodiment is different from the first embodiment in which the exposure period is shifted by one at the time of shifting to the next sub-frame period in that the exposure period is randomly switched at the time of shifting to the next sub-frame period. FIG. 6 is a diagram illustrating a control example of an exposure period and a light emission interval according to the second embodiment.

The g-th sub-frame period SF1_g illustrated in FIG. 6 includes a plurality of micro-frame periods MFg (for example, 100 micro-frame periods MFg). In the 99th micro-frame period MFg_99, the light emission period Lg_99 and the exposure period Eg_99 are illustrated. In the 100th micro-frame period MFg_100 indicating the last micro-frame period, the light emission period Lg_100 and the exposure period Eg_100 are illustrated. The period from the 99th light emission period Lg_99 to the 99th exposure period Eg_99 and the period from the 100th light emission period Lg_100 to the 100th exposure period Eg_100 are both periods T_g. In the period T_g, the reflected light from the object OJ at the distance value 5 can be received. In FIG. 6, in each of the micro-frame periods MFg_99 and MFg_100, distance values 1 to 10 proportional to the distance to the object OJ are described.

The exposure period setting unit 31 determines the 100th exposure period Eg_100 in the 100th micro-frame period MFg_100 illustrated in FIG. 6. In the 100th exposure period Eg_100, the reflected light from the object OJ at the distance value 5 with respect to the 100th light emission period Lg_100 can be received. The 100th micro-frame period MFg_100 is the last micro-frame period in the g-th sub-frame period SF1_g. After the end of the last micro-frame period, the process proceeds to an h-th sub-frame period SF1_h.

The h-th sub-frame period SF1_h is next to the g-th sub-frame period SF1_g. The h-th sub-frame period SF1_h includes a plurality of micro-frame periods MFh (for example, 100 micro-frame periods MFh). In the first micro-frame period MFh_1, the light emission period Lh_1 and the exposure period Eh_1 are illustrated. In the second micro-frame period MFh_2, the light emission period Lh_2 and the exposure period Eh_2 are illustrated. The period from the first light emission period Lh_1 to the first exposure period Eh_1 and the period from the second light emission period Lh_2 to the second exposure period Eh_2 are both periods T_h. In the period T_h, the reflected light from the object OJ at the distance value 2 can be received. In FIG. 6, in each of the micro-frame periods MFh_1 and MFh_2, distance values 1 to 10 proportional to the distance to the object OJ are described.

The exposure period setting unit 31 determines the first exposure period Eh_1 when the sub-frame period shifts from the g-th sub-frame period SF1_g to the h-th sub-frame period SF1_h. In the first exposure period Eh_1, the reflected light from the object OJ at the distance value 2 with respect to the first light emission period Lh_1 can be received. The first exposure period Eh_1 is a randomly determined. The exposure period setting unit 31 switches the exposure period when the sub-frame period shifts to the next sub-frame period, and in this case, randomly determines the next exposure period so that the exposure periods do not overlap with each other between the sub-frame periods. The exposure period setting unit 31 randomly determines the exposure period while applying all the exposure periods one time without overlapping the same exposure period in each sub-frame period when all the sub-frame periods are ended. Specifically, the exposure period setting unit 31 randomly determines the exposure periods corresponding to each of the ten regions (regions corresponding to the distance values 1 to 10) in the order of the distance values 5, 2, 6, 9, 1, 3, 8, 4, 10 and 7, for example.

The light emission control unit 32 controls the light emission interval W5 between the previous 100th light emission period Lg_100 and the next first light emission period Lh_1 based on the first exposure period Eh_1 determined by the exposure period setting unit 31. In this case, the light emission control unit 32 controls the light emission interval W5 so that the first exposure period Eh_1 is outside the period of the 100th micro-frame period MFg_100. This is to prevent the reflected light caused by the light emitted in the first light emission period L1_1 from being erroneously received in the second exposure period E1_2. In the present embodiment, the first exposure period Eh_1 is immediately after the end of the 100th micro-frame period MFg_100. Since the first exposure period Eh_1 corresponds to the distance value 2, the first light emission period Lh_1 corresponding to the first exposure period Eh_1 is before the end of the 100th micro-frame period MFg_100. Specifically, the first light emission period Lh_1 is before the distance value 10 of the 100th micro-frame period MFg_100. A light emission interval W5 between the 100th light emission period Lg_100 and the first light emission period Lh_1 corresponds to an interval including nine exposure periods and is different from the light emission interval W4 corresponding to an interval of six exposure periods.

As described above, after each of the exposure periods in which the start timing from the emission of the pulse light is the same is executed, the exposure period setting unit 31 randomly switches to the exposure period in which the start timing from the emission of the pulse light is different from the previous exposure period. The light emission control unit 32 changes the light emission interval according to the exposure period that is randomly switched. This makes it possible to avoid periodic light emission intervals in the frame period. For example, as illustrated in FIG. 6, at the time of shifting from the g-th sub-frame period SF1_g to the h-th sub-frame period SF1_h, the light emission interval W4 is changed to the light emission interval W5, and in this case, the exposure period corresponding to three light emission intervals is also changed. As a result, the ranging device 100 according to the second embodiment can significantly suppress interference with other ranging devices as compared with a case where the exposure period is shifted one by one.

### Third Embodiment

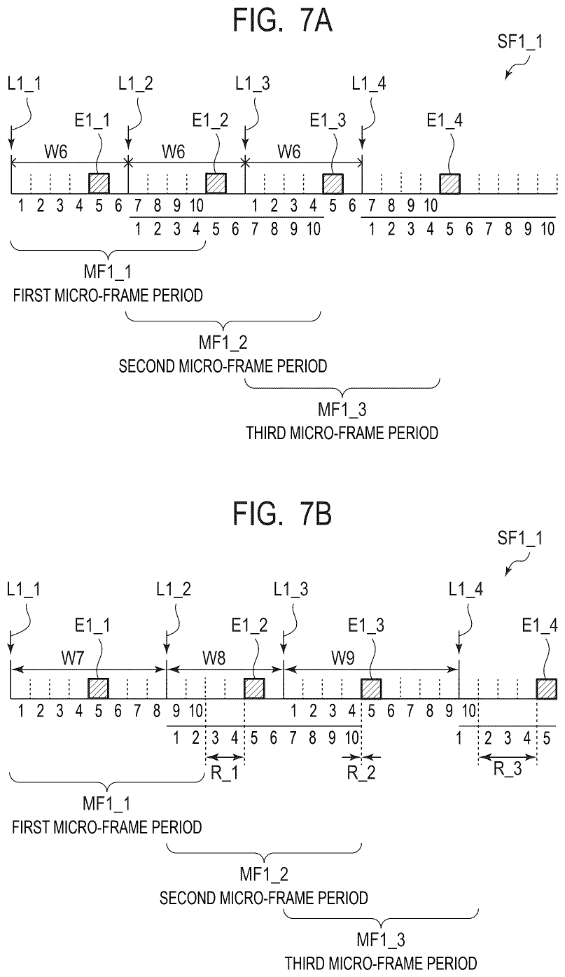

Next, an example of controlling the exposure period and the light emission interval according to the third embodiment will be described. The third embodiment differs from the first and second embodiments in that the light emission interval is changed randomly when shifting to the next micro-frame period within the same sub-frame period whereas the first and second embodiments maintain a constant light emission interval when shifting to the next micro-frame period. FIG. 7A illustrates an example in which the light emission interval is constant, and FIG. 7B illustrates an example in which the light emission interval is randomly changed.

The first sub-frame period SF1_1 illustrated in FIG. 7A includes a plurality of micro-frame periods MF1.

The exposure period setting unit 31 determines the first exposure period E1_1 in the first micro-frame period MF1_1 illustrated in FIG. 7A. In the first exposure period E1_1, for example, the reflected light from the object OJ at the distance value 5 with respect to the first light emission period L1_1 can be received.

The light emission control unit 32 outputs a light emission control signal indicating light emission in the first light emission period L1_1 to the light emitting unit 11 based on the first exposure period E1_1 determined by the exposure period setting unit 31.

Next, the exposure period setting unit 31 determines the second exposure period E1_2 in the second micro-frame period MF1_2. In the second exposure period E1_2, the reflected light from the object OJ at the distance value 5 with respect to the second light emission period L1_2 can be received as in the previous case.

Based on the second exposure period E1_2 determined by the exposure period setting unit 31, the light emission control unit 32 controls the light emission interval W6 between the previous first light emission period L1_1 and the next second light emission period L1_2. In this case, the light emission control unit 32 controls the light emission interval W6 so that the second exposure period E1_2 is outside the first micro-frame period MF1_1. This is to prevent the reflected light caused by the light emitted in the first light emission period L1_1 from being erroneously received in the second exposure period E1_2. In the present embodiment, the second exposure period E1_2 is immediately after the end of the first micro-frame period MF1_1. Since the second exposure period E1_2 corresponds to the distance value 5, the second light emission period L1_2 corresponding to the second exposure period E1_2 is before the end of the first micro-frame period MF1_1. Specifically, the second light emission period L1_2 is before the distance value 7 of the first micro-frame period MF1_1. A light emission interval W6 between the first light emission period L1_1 and the second light emission period L1_2 corresponds to an interval including six exposure periods. The light emission intervals of the third micro-frame period MF1_3, the fourth micro-frame period MF1_4, . . . , and the q-th micro-frame period MF1_q are also intervals of six exposure periods (q is an integer of 3 or more). Then, in the same sub-frame period, the light emission interval is made constant at the time of shifting to the next micro-frame period.

On the other hand, in the same sub-frame period, the light emission interval may be randomly switched to the next micro-frame period. The exposure period setting unit 31 determines the first exposure period E1_1 in the first micro-frame period MF1_1 illustrated in FIG. 7B. In the first exposure period E1_1, for example, the reflected light from the object OJ at the distance value 5 with respect to the first light emission period L1_1 can be received.

The light emission control unit 32 outputs a light emission control signal indicating light emission in the first light emission period L1_1 to the light emitting unit 11 based on the first exposure period E1_1 determined by the exposure period setting unit 31.

Next, the exposure period setting unit 31 determines the second exposure period E1_2 in the second micro-frame period MF1_2. In the second exposure period E1_2, the reflected light from the object OJ at the distance value 5 with respect to the second light emission period L1_2 can be received as in the previous case.

Based on the second exposure period E1_2 determined by the exposure period setting unit 31, the light emission control unit 32 controls the light emission interval W7 between the previous first light emission period L1_1 and the next second light emission period L1_2. In this case, the light emission control unit 32 controls the light emission interval W7 so that the second exposure period E1_2 is outside the first micro-frame period MF1_1. This is to prevent the reflected light caused by the light emitted in the first light emission period L1_1 from being erroneously received in the second exposure period E1_2. In the present embodiment, the second exposure period E1_2 is at the end of the first micro-frame period MF1_1. Specifically, the second exposure period E1_2 is separated from the end of the first micro-frame period MF1_1 by a period R_1 (two exposure periods). Since the second exposure period E1_2 corresponds to the distance value 5, the second light emission period L1_2 corresponding to the second exposure period E1_2 is before the end of the first micro-frame period MF1_1. Specifically, the second light emission period L1_2 is before the distance value 9 of the first micro-frame period MF1_1. A light emission interval W7 between the first light emission period L1_1 and the second light emission period L1_2 corresponds to an interval including eight exposure periods.

Next, the exposure period setting unit 31 determines the third exposure period E1_3 in the third micro-frame period MF1_3. In the third exposure period E1_3, the reflected light from the object OJ at the distance value 5 with respect to the third light emission period L1_3 can be received as in the previous case.

The light emission control unit 32 controls the light emission interval W8 between the previous second light emission period L1_2 and the next third light emission period L1_3 based on the third exposure period E1_3 determined by the exposure period setting unit 31. In this case, the light emission control unit 32 controls the light emission interval W8 so that the third exposure period E1_3 is outside the second micro-frame period MF1_2. This is to prevent the reflected light caused by the light emitted in the previous second light emission period L1_2 from being erroneously received in the third exposure period E1_3. In the present embodiment, the third exposure period E1_3 is immediately after the end of the second micro-frame period MF1_2. Specifically, the second exposure period E1_2 is separated from the end of the first micro-frame period MF1_1 by a period R_2 (0 exposure period). Since the third exposure period E1_3 corresponds to the distance value 5, the third light emission period L1_3 corresponding to the third exposure period E1_3 is before the end of the second micro-frame period MF1_2. Specifically, the third light emission period L1_3 is before the distance value 7 of the second micro-frame period MF1_2. A light emission interval W8 between the second light emission period L1_2 and the third light emission period L1_3 corresponds to an interval including six exposure periods, and is different from the light emission interval W7 corresponding to an interval including eight exposure periods. A light emission interval W9 between the third light emission period L1_3 and the fourth light emission period L1_4 corresponds to an interval including nine exposure periods, and is different from the light emission intervals W6 and W7. The fourth micro-frame period MF1_4, . . . , and the q-th micro-frame period MF1_q are similarly controlled (q is an integer of 3 or more).

As described above, when each of the micro-frame periods in which the exposure period having the same start timing from the emission of the pulse light is set is executed, the light emission control unit 32 randomly changes the light emission interval every time the micro-frame period is shifted. As a result, the ranging device 100 according to the third embodiment can avoid periodic light emission intervals in the sub-frame period, and can significantly suppress interference with other ranging devices.

### Fourth Embodiment

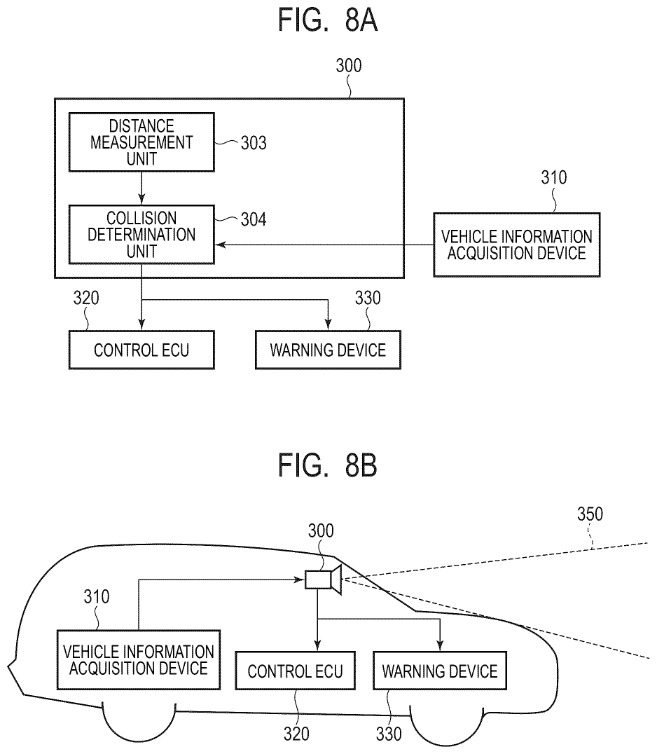

Movable body according to the fourth embodiment will be described with reference to FIGS. 8A and 8B. FIGS. 8A and 8B are diagrams illustrating a configuration example of movable body according to the fourth embodiment.

FIG. 8A illustrates a configuration example of a device mounted on a vehicle as an in-vehicle camera. The device 300 includes a distance measurement unit 303 that measures a distance to an object, and a collision determination unit 304 that determines whether there is a possibility of collision based on the distance measured by the distance measurement unit 303. The distance measurement unit 303 is configured by the ranging device 100 described in the first to third embodiments. Here, the distance measurement unit 303 is an example of a distance information acquisition unit that acquires distance information to an object. That is, the distance information is information related to a distance to an object or the like.

The device 300 is connected to the vehicle information acquisition device 310, and can acquire vehicle information such as a vehicle speed, a yaw rate, and a steering angle. In addition, a control ECU 320, which is a control device that outputs a control signal for generating a braking force to the vehicle based on the determination result of the collision determination unit 304, is connected to the device 300. The device 300 is also connected to an alarm device 330 that issues an alarm to the driver based on the determination result of the collision determination unit 304. For example, when the determination result of the collision determination unit 304 indicates that the possibility of collision is high, the control ECU 320 performs vehicle control to avoid collision and reduce damage by, for example, applying a brake, returning an accelerator, or suppressing engine output. The alarm device 330 gives a warning to the user by sounding a warning such as a sound, displaying warning information on a screen of a car navigation system or the like, giving vibration to a seat belt or a steering wheel, or the like. These devices of the device 300 function as a movable body control unit that controls the operation of controlling the vehicle as described above.

In the present embodiment, the distance to the surroundings of the vehicle, for example, the front or the rear is measured by the device 300. FIG. 8B illustrates a device in the case of distance measurement in front of the vehicle (distance measurement range 350). The vehicle information acquisition device 310 serving as the distance measurement control unit sends an instruction to the device 300 or the distance measurement unit 303 to perform the distance measurement operation. With such a configuration, the accuracy of distance measurement can be further improved.

In the above description, an example in which control is performed so as not to collide with another vehicle has been described, but the present invention is also applicable to control in which automatic driving is performed so as to follow another vehicle, control in which automatic driving is performed so as not to protrude from a lane, and the like. Furthermore, the device is not limited to vehicles such as automobiles, and can be applied to, for example, ships, aircrafts, artificial satellites, industrial robots, consumer robots, and the like movable body (mobile devices). In addition, the present invention is not limited to movable body, and can be widely applied to devices utilizing object recognition or biological recognition, such as an intelligent traffic system (ITS) and a monitoring system.

### Modified Embodiments

The present invention is not limited to the above-described embodiment, and various modifications are possible. For example, an example in which a part of the configuration of any of the embodiments is added to another embodiment or an example in which a part of the configuration of another embodiment is replaced with another embodiment is also an embodiment of the present invention.

In the above description, an example in which the micro-frame period is divided into ten periods (exposure periods) corresponding to the distance values 1 to 10has been described, but the present invention is not limited thereto, and the micro-frame period may be divided into other times.

Although the ranging device has been described in the above embodiment, the algorithm described in the above embodiment can also be applied to an information processing device for processing distance data indicating a distance to an object. In this case, in the configuration of the ranging device 100 illustrated in FIG. 2, the exposure period setting unit 31, the light emission control unit 32, the count holding unit 33, and the output unit 34 may be configured by an information processing device. The information processing device may be a device such as a personal computer including a processor (for example, a CPU or an MPU). Alternatively, the information processing device may be a circuit such as an ASIC that realizes the functions of the exposure period setting unit 31, the light emission control unit 32, the count holding unit 33, and the output unit 34.

In addition, although an example in which the function of calculating the distance to the object OJ is included in the external device has been described, the function is not limited thereto, and for example, the ranging device 100 may include the function.

The micro-frame period (unit detection period) may be a period from the emission of the pulse light to the elapse of a detection period having the latest start timing among the detection periods. In this case, all of the detection periods included in the micro-frame period may be set to the exposure period, or a part of the detection periods may be set to the exposure period. The exposure period setting unit 31 sets at least two or more of a plurality of detection periods to the exposure period, the detection periods are determined according to a time from emission of light to detection of light in one ranging operation.

According to the present invention, it is possible to realize a ranging device, a ranging method, and movable body capable of suppressing interference with other ranging devices while suppressing a decrease in frame rate.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-218494, filed Dec. 25, 2023, which is hereby incorporated by reference herein in its entirety.

What is claimed is:

1. A ranging device comprising:
a light emission control unit configured to control a light emitting unit that emits a pulse light;
a light receiving unit configured to detect a light signal including light emitted from the light emitting unit and reflected by an object in a measurement target region and convert the light signal into a pulse signal;
an exposure period setting unit configured to set one of a plurality of detection periods to an exposure period of the light receiving unit for each emission of the pulse light, wherein the plurality of detection periods are determined according to a time from emission of the light to detection of the light; and
a count holding unit configured to count and hold the number of the pulse signals in each of the exposure periods,
wherein when each of the plurality of detection periods is set, the light emission control unit causes the pulse light to be emitted at irregular light emission intervals that are shorter than a length corresponding to a length of a unit detection period which is defined as a period from the emission of the pulse light to an elapse of the detection period having the latest start timing among the plurality of detection periods.

2. The ranging device according to claim 1, wherein the light emission control unit controls the light emission intervals so that each of the plurality of detection periods is after the end of the unit detection period corresponding to the previous exposure period.

3. The ranging device according to claim 1,
wherein, at a first detection period, the light receiving unit receives a reflected light caused by a light emitted from the light emitting unit at a first light emission period in a first unit detection period among a plurality of unit detection periods,
wherein, at a second detection period, the light receiving unit receives a reflected light caused by a light emitted from the light emitting unit at a second light emission period in a second unit detection period following the first unit detection period, and
wherein the light emission control unit controls the second light emission period to be between the end of the first detection period and the end of the first unit detection period so that the second detection period is after the end of the first unit detection period.

4. The ranging device according to claim 3, wherein the light emission control unit shortens the light emission interval by a period corresponding to an integer multiple of the detection period.

5. The ranging device according to claim 1, wherein the light emission control unit randomly changes the light emission interval for each unit detection period.

6. The ranging device according to claim 1, wherein the light emission control unit randomly changes the light emission interval for each of a plurality of unit detection periods.

7. The ranging device according to claim 1, wherein the count holding unit acquires frequency distribution information that associates the detection period with a count value obtained by counting the number of the pulse signals.

8. The ranging device according to claim 1, wherein the exposure period setting unit sets at least two or more detection periods to the exposure periods in one ranging operation, among the plurality of detection periods determined according to a time from emission of the light to detection of the light.

9. A movable body comprising:
the ranging device according to claim 1; and
a control unit configured to control the movable body based on distance information acquired by the ranging device.

10. A ranging device comprising:
a light emission control unit configured to control a light emitting unit that emits a pulse light;
a light receiving unit configured to detect a light signal including light emitted from the light emitting unit and reflected by an object in a measurement target region and convert the light signal into a pulse signal;
an exposure period setting unit configured to set one of a plurality of detection periods to an exposure period of the light receiving unit for each emission of the pulse light, wherein the plurality of detection periods are determined according to a time from emission of the light to detection of the light; and
a count holding unit configured to count and hold the number of the pulse signals in each of the exposure periods,
wherein the exposure period setting unit outputs detection period information indicating the detection period to the light emission control unit,
wherein the light emission control unit determines a light emission period in which the light emitting unit is caused to emit light based on a start timing of a detection period indicated by the detection period information, outputs a light emission control signal indicating that the light emitting unit emits light in the light emission period to the light emitting unit, and further outputs a light emission notification indicating that the light emitting unit is controlled to emit light in the light emission period to the exposure period setting unit,
wherein the exposure period setting unit sets the detection period to the light receiving unit based on the light emission notification.

11. The ranging device according to claim 10, wherein the exposure period setting unit sets at least two or more detection periods to the exposure periods in one ranging operation, among the plurality of detection periods determined according to a time from emission of the light to detection of the light.

12. A movable body comprising:
the ranging device according to claim 10; and
a control unit configured to control the movable body based on distance information acquired by the ranging device.

13. A ranging method comprising:
controlling a light emitting unit that emits a pulse light;
setting one of a plurality of detection periods to an exposure period of a light receiving unit for each emission of the pulse light, wherein the light receiving unit detects a light signal including light emitted from the light emitting unit and reflected by an object in a measurement target region and converts the light signal into a pulse signal, wherein the plurality of detection periods are determined according to a time from emission of the light to detection of the light; and
counting and holding the number of the pulse signals in each of the exposure periods,
wherein when each of the plurality of detection periods is set, the controlling causes the pulse light to be emitted at irregular light emission intervals that are shorter than a length corresponding to a length of a unit detection period which is defined as a period from the emission of the pulse light to an elapse of the detection period having the latest start timing among the plurality of detection periods.

14. The ranging method according to claim 13, wherein the setting sets at least two or more detection periods to the exposure periods in one ranging operation, among the plurality of detection periods determined according to a time from emission of the light to detection of the light.
